(19) United States
(12) Patent Application Publication
(10) Pub. No.: US 2026/0334507 A1
(43) Pub. Date: Oct. 29, 2026

(54) VEGAN FISH SUBSTITUTE AND METHODS OF MAKING SAME

(71) Applicant: VGARDEN LTD., Hefer (IL)

(72) Inventors: Eyal ADUT, Hefer (IL); Omer ELIAV, Beer Ganim (IL)

(21) Appl. No.: 19/111,548

(22) PCT Filed: Sep. 14, 2023
(86) PCT No.: PCT/IL2023/051003

§ 371 Date: Mar. 13, 2025

(30) Foreign Application Priority Data
Sep. 15, 2022 (IL) 296553

(51) Int. Cl. A23J 3/14; A23L 11/00

(52) U.S. Cl. CPC A23J 3/14; A23L 11/01

(57) ABSTRACT

A vegan fish substitute is disclosed. The vegan fish substitute comprising: between 50 to 70 wt. % water-saturated legume protein flakes; between 3 to 5 wt. % edible fibers; and between 25 to 35 wt. % vegetable oil, wherein all the water is contained in the saturated legume protein flakes.

### CROSS-REFERENCE TO RELATED APPLICATIONS

This application claims the benefit of priority of Israeli Patent Application No. 296553, titled “VEGAN FISH SUBSTITUTE AND METHODS OF MAKING SAME”, filed Sep. 15, 2022, the contents of which are incorporated herein by reference in their entirety.

### FIELD OF THE INVENTION

The present invention relates to a vegan analog product. More particularly, the present invention relates to an instant vegan fish substitute.

### BACKGROUND OF THE INVENTION

Fish and meat analogs, for example, tuna vegan substitute, beef vegan substitute, lamb vegan substitute, pork vegan substitute, chicken vegan substitute products and the like become very popular in recent years. Due to nutritive benefits, moral issues and environmental considerations, the analog markets are one of the most growing food markets in the last decade.

Most of the known fish analog products contain legumes as a source of protein mixed with stabilizers, pigments, and flavors. The stabilizers are added in order to form the “fish-like” texture and the pigments and flavors to form the requested appearance and taste.

Tuna products, for example, canned tuna, continue large amounts of water and oil and have a very specific texture which is hard to mimic with legumes.

Tuna is the most common fish product sold all across the globe. In recent years there is a concern regarding the findings of mercury inside canned tuna, which increase the need for a better mercury-free substitute.

Accordingly, there is a need for a vegan fish substitute mimicking the texture and flavor of natural fish, such as Tuna.

### SUMMARY OF THE INVENTION

Some aspects of the invention may be directed to a vegan fish substitute, comprising: between 50 to 70 wt. % water-saturated legume protein flakes; between 3 to 5 wt. % edible fibers; and between 25 to 35 wt. % vegetable oil, wherein all the water is contained in the saturated legume protein flakes.

In some embodiments, the water-saturated legume protein comprises dry legume protein flakes and water in a ratio of between 0.2 to 0.55 (dry legume protein flakes)/(water). In some embodiments, the vegan fish substitute further comprises at least one of: salt, flavoring and pigments.

In some embodiments, the water-saturated legume protein flakes comprise pea proteins, chickpea protein, beans protein, soybeans protein, lentil protein, lupins protein, and a combination thereof. In some embodiments, the edible fibers are cellulose fibers. In some embodiments, vegetable oil is selected from, sunflower oil, soy oil, olive oil, grape oil, and canola oil.

Some additional aspects of the invention may be directed to a method of making a vegan fish substitute, comprising:
(a) soaking dry legume protein flakes with water in a ratio of between 0.2 to 0.55 (dry legume protein flakes)/(water) until achieving full saturation of the water inside the legume protein flakes, resulting in saturated legume protein flakes;
(b) adding between 3 to 5 wt. % edible fibers and mixing with the water-saturated legume protein flakes; and
(c) adding between 25 to 35 wt. % vegetable oil and mixing with the water-saturated legume protein flakes and edible fibers mixture.

In some embodiments, pigments are added to the water prior to mixing with the dry legume protein flakes. In some embodiments, the method further comprises adding salt and flavoring to the saturated legume protein flakes prior to adding the edible fibers. In some embodiments, the water is provided at a temperature above room temperature.

### BRIEF DESCRIPTION OF THE DRAWINGS

The subject matter regarded as the invention is particularly pointed out and distinctly claimed in the concluding portion of the specification. The invention, however, both as to organization and method of operation, together with objects, features, and advantages thereof, may best be understood by reference to the following detailed description when read with the accompanying drawings in which:

FIG. 1 shows a flowchart of a method of making a vegan fish substitute, according to some embodiments of the invention.

It will be appreciated that for simplicity and clarity of illustration, elements shown in the figures have not necessarily been drawn to scale. For example, the dimensions of some of the elements may be exaggerated relative to other elements for clarity. Further, where considered appropriate, reference numerals may be repeated among the figures to indicate corresponding or analogous elements.

### DETAILED DESCRIPTION OF THE PRESENT INVENTION

In the following detailed description, numerous specific details are set forth in order to provide a thorough understanding of the invention. However, it will be understood by those skilled in the art that the present invention may be practiced without these specific details. In other instances, well-known methods, procedures, and components have not been described in detail so as not to obscure the present invention.

The current invention relates to a vegan fish substitute. Such vegan fish substitute may have similar texture to real fish, for example, canned fishes, such as canned tuna and canned salmon. The required texture may be achieved by providing and maintaining sufficient amount water inside a vegan based protein. In some embodiments, vegan based protein flakes are saturated with water, such that, water is soaked into the protein macrostructure and maintained in the structure during the production stage, the storing stage and during consumption (e.g., eating and cooking).

As used herein legume protein flakes are flakes made from one or more types of legume proteins, for example, pea proteins, chickpea protein, beans protein, soybeans protein, lentil protein, lupins protein, and a combination thereof.

As used herein flakes are thin flattened pieced or layers. Therefore, legume protein flakes are thin flattened pieced or layers of legume protein. The flakes size may be between 2-20 millimeters, (e.g., the average diameter of the flattened piece).

A vegan fish substitute according to embodiments of the invention may include between 40 to 80 wt. % (or any value in between) water-saturated legume protein flakes, for example, between 50 to 70 wt. % water-saturated legume protein flakes. In some embodiments, the water-saturated legume protein flakes may include dry legume protein flakes and water in a ratio of between 0.2 to 0.55 flakes/water, and any value in between. In some embodiments, all the water is contained in the legume protein flakes microstructure, with no residual water.

In some embodiments, the ratio between the dry legume protein flakes and the water may be: between 0.2 to 0.5, between 0.1 to 0.6, between 0.2 to 0.4, between 0.3 to 0.55, between 0.25 to 0.45, between 0.25 to 0.35 and any value in between.

In some embodiments, the vegan fish substitute may further include between 3 to 5 wt. % edible fibers. Some nonlimiting examples for edible fibers may include are cellulose fibers, sugar cane fibers, and the like. In some embodiments, the vegan fish substitute may further include between 2 to 6 wt. % edible fibers, between 2 to 5 6 wt. % edible fibers, between 2.5 to 5.5 wt. %, between 3.5 to 4.5 wt. % and any value in between.

In some embodiments, the vegan fish substitute may further include between 25 to 35 wt. % vegetable oil. Some nonlimiting examples for vegetable oil may include, nonhydrogenated vegetable oil, such as, canola oil, sunflower oil, olive oil, soybeans oil, grape oil, and the like. In some embodiments, the vegan fish substitute may further include between 20 to 50 wt. % vegetable oil, between 15 to 50 wt. % vegetable oil, between 30 to 40 wt. % vegetable oil, between 25 to 30 wt. % vegetable oil, between 28 to 32 wt. % vegetable oil and any value in between.

In some embodiments, the vegan fish substitute may further include at least one of: salt, flavoring and pigments. In a nonlimiting example, the flavoring may include tuna flavor, such sa GH-470-221-8 of Givaudan® which includes. In a nonlimiting example, the pigment may include caramel color/pigment such as, E150a, E150b, E150c or E150d.

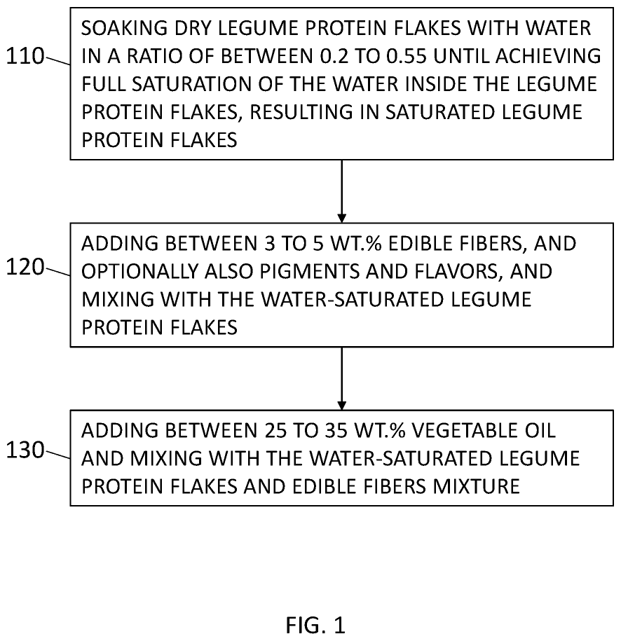

Reference is now made to FIG. 1 which is a flowchart of a method of making a vegan fish substitute according to some embodiments of the invention.

In step 110, dry legume protein flakes may be soaked with water in a ratio of between 0.2 to 0.55 until achieving full saturation of the water inside the legume protein flakes, resulting in saturated legume protein flakes. In some embodiments, the dry legume protein flakes may be immersed and soaked in the water for 7-10 minutes. In some embodiments, the water may be provided at a temperature above room temperature, for example, at 40 ° C, 50 ° C, 60 ° C, 70 ° C, 80 ° C, 90 ° C, 100 ° C and any value in between.

In some embodiments, pigments may be added to the water prior to the addition of the dry legume protein flakes.

For example, 25 grams of dry legume protein flakes may be soaked with 45-55 grams of warm water.

In step 120, between 3 to 5 wt. % edible fibers may be added and mixed with the water-saturated legume protein flakes. In some embodiments, salt and flavoring may be added to the saturated legume protein flakes prior to adding the edible fibers. Alternatively, the salt and flavoring may be added to the water together with the pigment.

In step 130, between 25 to 35 wt. % vegetable oil may be added and mixed with the water-saturated legume protein flakes and edible fibers mixture.

The mixing may be conducted using any suitable food mixer, for example, ribbon mixer, low-speed mixer, high-speed shopper, and the like.

### EXAMPLES

### Example 1-Preparing Vegan Tuna Substitute

A vegan tuna substitute was prepared using the method disclosed above. Table 1 summarizes the composition of the final product.

TABLE 1

| Component | Amount wt. % |
|---|---|
| Pea protein flakes | 17 |
| Water | 45.5 |
| Cellulose Fibers | 3.4 |
| Sunflower Oil | 30 |
| Tuna flavors | 2.7 |
| Caramel Colorant | 0.1 |
| salt | 1.3 |

The vegan tuna substitute had a canned tuna-like texture, with moist flakes having the color and taste of a real canned tuna.

Previous attempts to achieve the requested texture using stabilizers and carbohydrates such as, Carboxymethyl cellulose (CMC), Carrageenan, potato starch, and the like, failed. The mixture turned soft and sticky. Soaking the dry legume protein flakes in warm water, gave better results. However, adding insufficient amount of water (e.g., above the ratio of 0.55 or 0.6 flakes/water) result in a dry hard and crunchy product. Adding too much water (e.g., below the ratio of 0.2 flakes/water) result in having wet flakes and excess water. Adding xanthan gum and/or squeezing the mixture with the excess water, did not result in the required tuna like texture.

While certain features of the invention have been illustrated and described herein, many modifications, substitutions, changes, and equivalents will now occur to those of ordinary skill in the art. It is, therefore, to be understood that the appended claims are intended to cover all such modifications and changes as fall within the true spirit of the invention.

1. A vegan fish substitute, comprising:
between 50 to 70 wt. % water-saturated legume protein flakes;
between 3 to 5 wt. % edible fibers; and
between 25 to 35 wt. % vegetable oil,
wherein all the water is contained in the saturated legume protein flakes,
and wherein the water-saturated legume protein comprises dry legume protein flakes and water in a ratio of between 0.2 to 0.55 (wt. % dry legume protein flakes)/(wt. % water).

2. The vegan fish substitute of claim 1, further comprising at least one of: salt, flavouring and pigments.

3. The vegan fish substitute according to claim 1, wherein the water-saturated legume protein flakes comprise pea protein flakes.

4. The vegan fish substitute according to claim 1, wherein the water-saturated legume protein flakes comprise at least on of: pea proteins, chickpea protein, beans protein, soybeans protein, lentil protein, lupins protein, and a combination thereof.

5. The vegan fish substitute according to claim 1, wherein the edible fibers are cellulose fibers.

6. The vegan fish substitute according to claim 1, wherein the vegetable oil is selected from, sunflower oil, soy oil, olive oil, grape oil, and canola oil.

7. A method of making a vegan fish substitute, comprising:
(a) soaking dry legume protein flakes with water in a ratio of between 0.2 to 0.55 (wt. % dry legume protein flakes)/(wt. % water) until achieving full saturation of the water inside the legume protein flakes, resulting in saturated legume protein flakes;
(b) adding between 3 to 5 wt. % edible fibers and mixing with the water-saturated legume protein flakes; and
(c) adding between 25 to 35 wt. % vegetable oil and mixing with the water-saturated legume protein flakes and edible fibers mixture.

8. The method of claim 7, wherein pigments are added to the water prior to mixing with the dry legume protein flakes.

9. The method of claim 7, further comprising adding salt and flavouring to the saturated legume protein flakes prior to adding the edible fibers.

10. The method according to claim 7, wherein the water is provided at a temperature above room temperature.
